(19) United States
(12) Patent Application Publication
(10) Pub. No.: US 2013/0162504 A1
(43) Pub. Date: Jun. 27, 2013

(54) DISPLAY DEVICE

(71) Applicant: Masayuki KAWANO, Tokyo (JP)

(72) Inventor: Masayuki KAWANO, Tokyo (JP)

(21) Appl. No.: 13/724,661

(22) Filed: Dec. 21, 2012

(30) Foreign Application Priority Data
Dec. 22, 2011 (JP) 2011-281190

(51) Int. Cl. G06F 3/14

(52) U.S. Cl. CPC G06F 3/1446
USPC 345/1.3

(57) ABSTRACT

A display device includes display units arranged with a predetermined space therebetween, each being capable of independently displaying an image, protection plates each being disposed at a front of each of the display units with a back surface thereof facing a display surface of each of the display units, a connecting sheet having flexibility and being stuck to the back surface of each of the protection plates to connect the protection plates to each other, and translucent adhesive layers each being disposed so as to cover the display surface of each of the display units. The protection plates connected by the connecting sheet are bonded to the display units by the translucent adhesive layers with the connecting sheet interposed therebetween or directly, so that the display units are connected to each other.

### BACKGROUND OF THE INVENTION

1. Field of the Invention

The present invention relates to a display device and, particularly, to a display device including a bent or curved overall display surface.

2. Description of the Background Art

Recently, a liquid crystal display (LCD) as a display device has been widely used for various purposes due to its advantages such as lightness and thinness.

A liquid crystal display panel used in a liquid crystal display has a configuration in which glass substrates on each of which a line and an electrode are formed are disposed so as to face each other and a liquid crystal is sandwiched between the substrates. Further, a polarizing plate is stuck to each side of image display surfaces, namely a front surface side, and a back surface side opposite thereto of the liquid crystal display panel.

On one of the glass substrates, a thin film transistor (TFT) and a pixel electrode are disposed in a region that is surrounded by a plurality of scanning lines (gate lines) arranged in a horizontal direction and a plurality of signal lines (source lines) perpendicular to the scanning lines so as to form a matrix. This substrate is also referred to as a TFT substrate. An opposite electrode to which a certain voltage is supplied is formed on the other glass substrate which is also referred to as a counter substrate. Further, a single pixel is composed of the pixel electrode, the opposite electrode, and a liquid crystal layer which is sandwiched between the pixel electrode and the opposite electrode.

Scanning signals are sequentially applied to the scanning lines of the TFT substrate at each horizontal scan period and, further, predetermined signal voltages are sequentially applied to vertical signal lines (source lines), so that a display voltage is applied to the corresponding pixel electrode. As a result, an image is displayed.

The displayed image is visibly recognized by an observer by irradiation of light from a backlight which is installed on a back side of the liquid crystal display panel.

As just described, a liquid crystal display is a so-called light-receiving type display device including a liquid crystal display panel which controls light transmittance for each pixel and a backlight, and used for a variety of purposes that take advantage of the characteristics thereof. For example, a liquid crystal display is used as a display for a personal computer, a display for devices that are used for industrial purposes, an in-car display, a display for a handy terminal, or an advertisement display device.

Since a high quality of design is also required in these display devices which are used in various environments, a display device having a curved shape has been developed.

As a method for manufacturing a curved display device, Japanese Patent Application Laid-Open No. 04-104122 (1992) discloses a technique for causing curvature of a liquid crystal display panel by heating and cooling the liquid crystal display panel using a forming die, for example. Further, Japanese Patent Application Laid-Open No. 2009-42565 discloses a method for obtaining a curved liquid crystal display panel using a glass substrate that has opposite glass curvatures between an end area thereof and the other area thereof. Furthermore, Japanese Patent Application Laid-Open No. 2005-91873 discloses a method for obtaining a liquid crystal display having a curved display surface in which a plurality of liquid crystal display panels are adjacently arranged, and a polarizing plate is stuck to the liquid crystal display panels so as to extend between the liquid crystal display panels and then stuck to a supporting body having a concave lens-like curved surface so as to cause curvature of each of the liquid crystal display panels along the curved surface of the supporting body.

As described above, a liquid crystal display panel used in a liquid crystal display is formed by sticking two glass substrates. However, since a glass substrate has high stiffness, a complicated manufacturing process such as heating and cooling as disclosed in Japanese Patent Application Laid-Open No. 04-104122 (1992) is required to cause curvature of the liquid crystal display panel and it is, therefore, not easy to cause curvature of the liquid crystal display panel. Further, there is necessity to use such a special glass substrate as the glass substrate disclosed in Japanese Patent Application Laid-Open No. 2009-42565, the glass substrate having opposite glass curvatures between the end area thereof and the other area thereof.

Further, in the method disclosed in Japanese Patent Application Laid-Open No. 2005-91873, it is necessary to reduce the thickness of each of the liquid crystal display panels to cause curvature of each of the liquid crystal display panels along the curved surface of the supporting body, which causes such a problem that the liquid crystal display panel easily gets broken. In addition, in a configuration including a protection plate for protecting a liquid crystal display panel from external shocks, when causing curvature of the liquid crystal display panel, the liquid crystal display panel may be broken due to a difference in stiffness between the liquid crystal display panel and the protection plate.

### SUMMARY OF THE INVENTION

It is an object of the present invention to provide a display device provided with a protection plate, the display device including a bent or curved overall display surface, without going through a complicated manufacturing process and without using a special glass substrate.

According to a first aspect of the present invention, a display device includes a plurality of display units arranged with a predetermined space therebetween, each of the plurality of display units having a display surface and being capable of independently displaying an image, a plurality of protection plates, each being disposed at a front of each of the plurality of display units with a back surface thereof facing each of the plurality of display units, a connecting sheet having flexibility, the connecting sheet being stuck to the back surface of each of the plurality of protection plates to connect the plurality of protection plates to each other, and translucent adhesive layers, each being disposed so as to cover the display surface of each of the plurality of display units. Further, the plurality of protection plates connected by the connecting sheet are bonded to the plurality of display units by the translucent adhesive layers with the connecting sheet interposed therebetween or directly, so that the plurality of display units are connected to each other. Further, the display device can be configured so that the display surface of each of the plurality of display units faces a different direction by bending a connection part connected by the connecting sheet, the connection part corresponding to a position of the predetermined space between the plurality of display units.

According to the display device of the first aspect, it is possible to obtain a display device including a bent overall display surface without going through a complicated manufacturing process and without using a special glass substrate.

According to a second aspect of the present invention, a display device includes a plurality of display units, each having a display surface and being capable of independently displaying an image, a protection plate disposed at a front of the plurality of display units with a back surface thereof facing the plurality of display units, translucent adhesive layers, each being disposed so as to cover the display surface of each of the plurality of display units. Further, the protection plate is bent at a plurality of bent portions to have a plurality of sections each facing a different direction. Further, each of the plurality of display units is bonded to a back surface of each of the plurality of sections of the protection plate by each of the translucent adhesive layers, so that the plurality of display units are connected to each other and the display surface of each of the plurality of display units faces a different direction.

According to the display device of the second aspect, it is possible to obtain a display device including a curved overall display surface without going through a complicated manufacturing process and without using a special glass substrate.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view illustrating a schematic configuration of a display device according to a first preferred embodiment of the present invention;

FIG. 2 is a side view illustrating the display device according to the first preferred embodiment of the present invention, the display device being used in a bent state so that an overall display surface thereof has a concave shape;

FIG. 3 is a side view illustrating the display device according to the first preferred embodiment of the present invention, the display device being used in a bent state so that an overall display surface thereof has a convex shape;

FIG. 4 is a side view illustrating the display device according to the first preferred embodiment of the present invention in which a concave protection plate is used;

FIG. 5 is a side view illustrating the display device according to the first preferred embodiment of the present invention in which a convex protection plate is used;

FIG. 6 is an exploded perspective view illustrating a schematic configuration of a display device according to a modification 1 of the first preferred embodiment of the present invention;

FIG. 7 is an exploded perspective view illustrating a schematic configuration of a display device according to a modification 2 of the first preferred embodiment of the present invention;

FIG. 8 is a side view illustrating the display device according to the modification 2 of the first preferred embodiment of the present invention;

FIG. 9 is a side view illustrating a display device according to a second preferred embodiment of the present invention, the display device being used in a bent state so that an overall display surface thereof has a concave shape;

FIG. 10 is a side view illustrating the display device according to the second preferred embodiment of the present invention, the display device being used in a bent state so that an overall display surface thereof has a convex shape;

FIG. 11 is a side view illustrating the display device according to the second preferred embodiment of the present invention in which a concavely curved protection plate is used; and

FIG. 12 is a side view illustrating the display device according to the second preferred embodiment of the present invention in which a convexly curved protection plate is used.

### DESCRIPTION OF THE PREFERRED EMBODIMENTS

### First Preferred Embodiment

### Configuration of Device

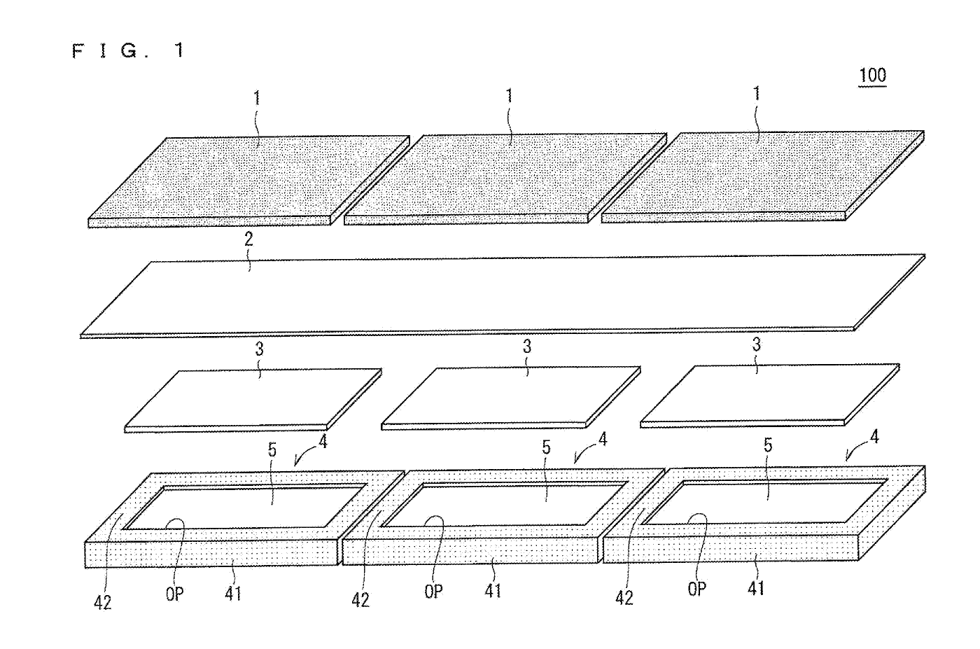

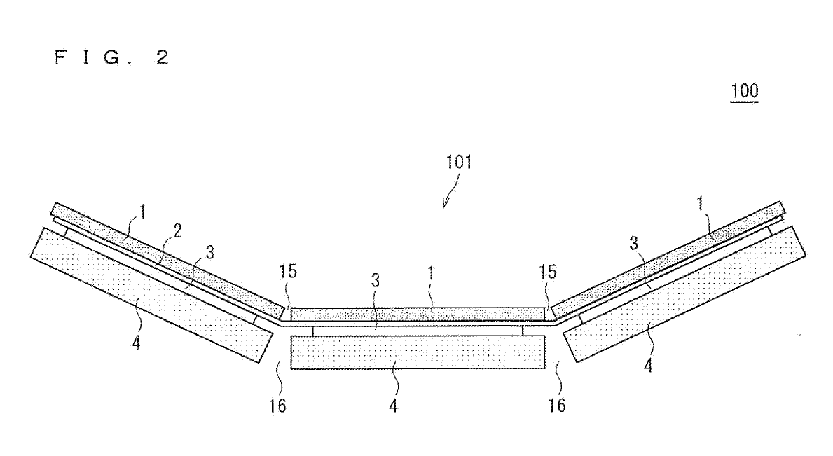

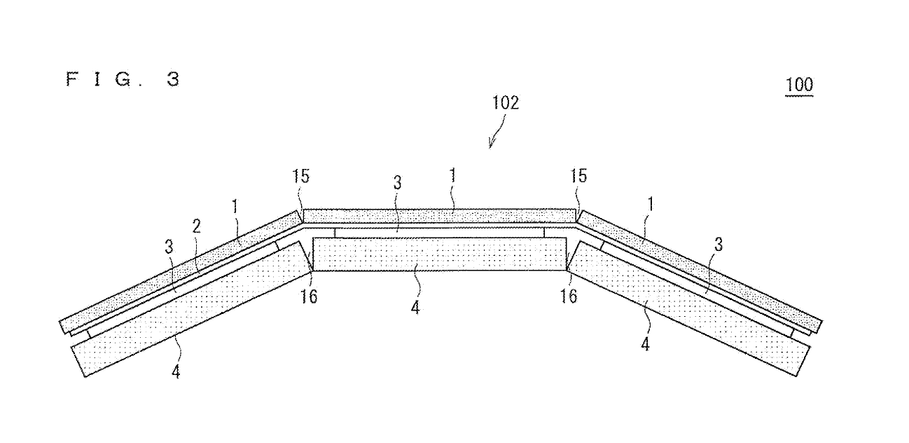

FIG. 1 is an exploded perspective view illustrating a schematic configuration of a display device 100 according to a first preferred embodiment of the present invention; FIG. 2 is a side view illustrating the display device 100 shown in FIG. 1, the display device 100 being used in a bent state so that an overall display surface 101 thereof has a concave shape; and FIG. 3 is a side view illustrating the display device 100 used in a bent state so that an overall display surface 102 thereof has a convex shape.

As shown in FIG. 1, in the display device 100, a plurality of display units 4 are arranged so that paired sides, such as a long side with a long side or a short side with a short side, are parallel to each other, and a connecting sheet 2 is stuck to image display surfaces, namely front surfaces, of the display units 4 so as to extend throughout the display units 4 to thereby connect the display units 4 to each other.

Each of the display units 4 is provided with a flat display panel inside thereof, such as a liquid crystal display panel, a plasma display panel (PDP), an organic EL display (OELD) panel, and a field emission display (FED) panel. Further, when the display unit 4 includes a liquid crystal display panel, the display unit 4 is also provided with a backlight which is disposed at a back side of the liquid crystal display panel. In addition, the present invention does not relate to an internal configuration of the display unit 4. Therefore, a panel other than the panels listed above may be used as long as the panel is a flat display panel and has a configuration to independently operate as a display device.

Each of the display units 4 has a configuration in which a flat display panel is housed in a thin housing 41 which has an opening OP on one of main surfaces, and a display surface 5 is exposed through the opening OP. Further, a part of the housing 41, the part surrounding the opening OP, is referred to as a frame 42.

The display units 4 are adjacently arranged so that display surfaces 5 of all of the display units 4 face the same direction and paired sides are parallel to each other.

A plurality of tabular protection plates 1 each of which is composed of a transparent material such as acrylic, polycarbonate, and glass are disposed on the respective display surfaces 5 of the respective display units 4 for protecting the display units 4 from external shocks. The protection plates 1 are not directly attached to the display units 4, but stuck to the connecting sheet 2.

That is, the protection plates 1 are arranged so that back surfaces thereof face the respective display surfaces 5 of the respective display units 4, and so as to conform to the arrangement of the display units 4. Further, the connecting sheet 2 which is composed of a flexible transparent material such as polyethylene terephthalate (PET), polycarbonate, polyester, and silicon is stuck to the back surfaces of the protection plates 1 so as to extend throughout the protection plates 1. Further, an adhesive (not shown) is applied to a front surface, namely a main surface that faces the back surfaces of the protection plates 1, of the connecting sheet 2. Accordingly, the connecting sheet 2 is stuck to the protection plates 1 so as to extend throughout the protection plates 1 by placing the protection plates 1 on the front surface of the connecting sheet 2.

The area of the connecting sheet 2 is larger than the total area of the arranged protection plates 1 and also than the total area of the arranged display units 4. Therefore, when the connecting sheet 2 with the protection plates 1 stuck thereto is placed on the arranged display units 4, the protection plates 1 completely cover the respective display surfaces 5 of the respective display units 4.

The connecting sheet 2 and the display units 4 are bonded to each other in such a manner that translucent adhesive layers 3 are provided so as to cover the respective display surfaces 5 of the respective display units 4, and the back surface of the connecting sheet 2 is stuck to the translucent adhesive layers 3. In this case, there is no air space between the back surface of the connecting sheet 2 and the display surfaces 5 of the display units 4 due to the presence of the translucent adhesive layers 3. An acrylic adhesive, an epoxy adhesive, a silicon adhesive and the like are used as the translucent adhesive layers 3.

Further, when the display device 100 is bent concavely and convexly as shown in FIG. 2 and FIG. 3, the protection plates 1 are arranged with a predetermined distance therebetween so as to form a gap 15 between adjacent protection plates 1 and the display units 4 are arranged with a predetermined distance therebetween so as to form a gap 16 between adjacent display units 4.

Further, when an overall display surface of the display device 100 is formed into a concave shape as shown in FIG. 2, the connecting sheet 2 is bent at a part, the part corresponding to the gap 15 and the gap 16, so as to expand at one side facing the gap 16 and contract at the other side facing the gap 15. As a result, a concave overall display surface 101 of the display device 100 is formed by a combination of the display surfaces 5 of the display units 4.

On the other hand, when an overall display surface of the display device 100 is formed into a convex shape as shown in FIG. 3, the connecting sheet 2 is bent at a part (connection part), the part corresponding to the gap 15 and the gap 16, so as to expand at one side facing the gap 15 and contract at the other side facing the gap 16. As a result, a convex overall display surface 102 of the display device 100 is formed by a combination of the display surfaces 5 of the display units 4.

As described above, in the display device 100 according to the first preferred embodiment, it is possible to obtain the display device 100 including the concave overall display surface 101 or the convex overall display surface 102 by sticking the flexible connecting sheet 2 to the protection plates 1 so as to extend throughout the protection plates 1 to thereby connect the display units 4 to each other and bending the connection sheet 2 at the connection part.

Therefore, a complicated manufacturing process for causing curvature of a flat display panel that is composed of glass substrates is not required. As a result, a manufacturing process can be simplified. In addition, there is no possibility of damaging a flat display panel and a protection plate.

Further, since the connection part is composed of the connecting sheet 2, it is possible to bendably connect the display units 4 to each other and the protection plates 1 to each other and position each of the display surfaces so as to face a different direction without increasing the number of components such as a hinge member.

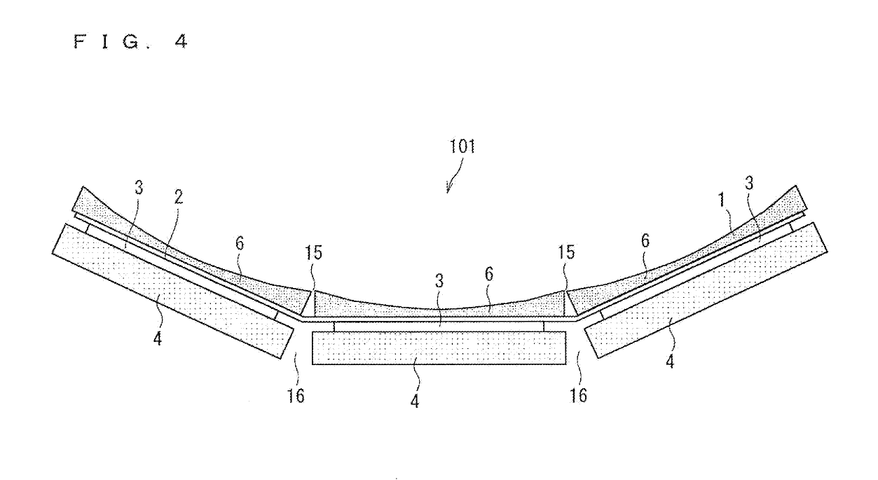

Further, although the protection plate 1 has a tabular shape in the above description, the shape of the protection plate 1 is not limited thereto. For example, as shown in FIG. 4, when the display device 100 is configured to have the concave overall display surface 101, a protection plate 6 in which one main surface thereof which is to be stuck to the connecting sheet 2 is formed into a flat surface and the other main surface opposite thereto is formed into a concave surface may be used.

In this manner, conforming the shape of the protection plate 6 to the shape of the concave overall display surface 101 of the display device 100 makes it possible to meet required specifications, shape or design.

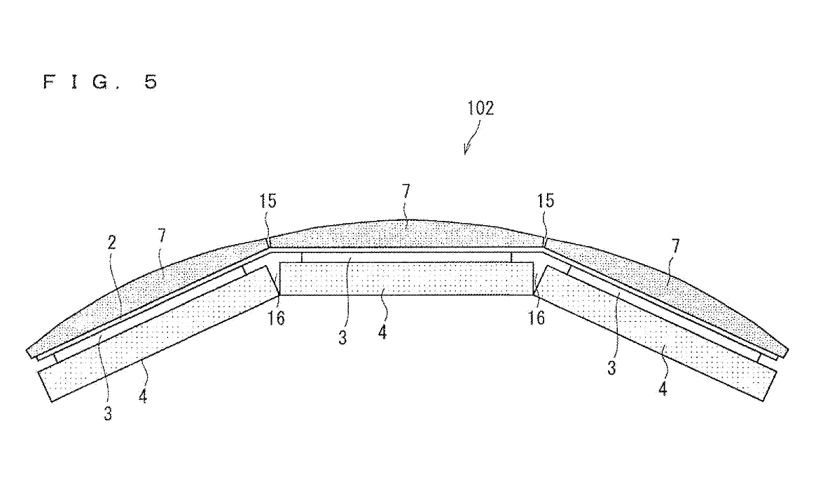

Further, as shown in FIG. 5, when the display device 100 is configured to have the convex overall display surface 102, a protection plate 7 in which one main surface thereof which is to be stuck to the connecting sheet 2 is formed into a flat surface and the other main surface opposite thereto is formed into a convex surface may be used.

In this manner, conforming the shape of the protection plate 7 to the shape of the convex overall display surface 102 of the display device 100 makes it possible to meet required specifications, shape or design.

### Modification 1

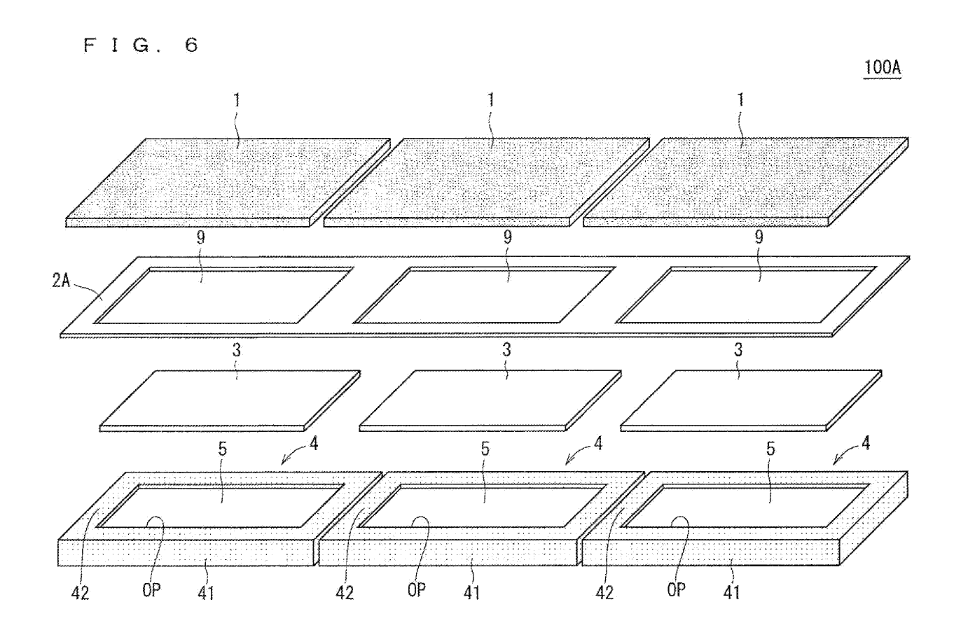

FIG. 6 is an exploded perspective view illustrating a schematic configuration of a display device 100A according to a modification 1 of the first preferred embodiment of the present invention. In the modification 1, the same reference numeral is assigned to a component having the same configuration as that in the display device 100 shown in FIG. 1, and the duplicate description will be omitted.

Further, descriptions of a side view illustrating the display device 100A used in a bent state so that an overall display surface thereof has a concave shape and a side view illustrating the display device 100A used in a bent state so that an overall display surface thereof has a convex shape are respectively the same as the descriptions which were made with reference to FIG. 2 and FIG. 3.

As shown in FIG. 6, in the display device 100A, a plurality of protection plates 1 are arranged so that back surfaces thereof face respective display surfaces 5 of respective display units 4, and so as to conform to the arrangement of the display units 4. In addition, a connecting sheet 2A which is composed of a flexible transparent material such as PET, polycarbonate, polyester, and silicon is stuck to the back surfaces of the protection plates 1 so as to extend throughout the protection plates 1.

The external size of the connecting sheet 2A is larger than the external size of the arranged protection plates 1 and also than the external size of the arranged display units 4. Further, the connecting sheet 2A has a configuration like a row of window frames in which regions of the connecting sheet 2A, the regions being overlapped with the display surfaces 5 of the display units 4, are formed into openings 9.

Further, an adhesive (not shown) is applied to a front surface, namely a main surface that faces the back surfaces of the protection plates 1, of the connecting sheet 2A. Accordingly, the connecting sheet 2A is stuck to the protection plates 1 so as to extend throughout the protection plates 1 by placing the protection plates 1 on the front surface of the connecting sheet 2A.

The connecting sheet 2A and the display units 4 are bonded to each other in such a manner that translucent adhesive layers 3 are provided so as to cover the respective display surfaces 5 of the respective display units 4, and back surfaces of window frame regions around the openings 9 of the connecting sheet 2A are stuck to the translucent adhesive layers 3. In this case, the back surface of each of the protection plates 1 and the display surface 5 of each of the display units 4 are directly bonded to each other by the respective translucent adhesive layers 3 and there is, therefore, no air space therebetween due to the presence of the translucent adhesive layer 3.

The use of the connecting sheet 2A which has the openings 9 at the regions overlapped with the display surfaces 5 of the display units 4 results in absence of a member of the connecting sheet 2A on the display surfaces 5. Accordingly, it is possible to reduce color change or brightness change of a displayed image which is caused by existence of a member of the connecting sheet 2A on the display surface 5.

Further, although the description has been made regarding the connecting sheet 2A that is composed of a transparent material, a constituent material of the connecting sheet 2A is not limited to a transparent material because the connecting sheet 2A is not overlapped with the display surfaces 5 of the display units 4.

### Modification 2

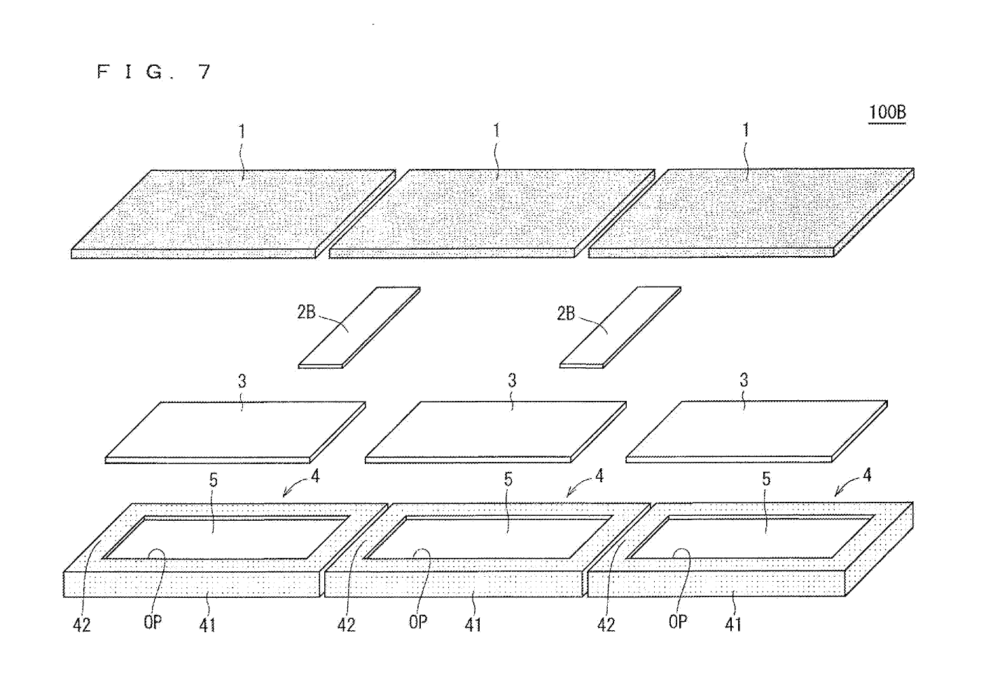

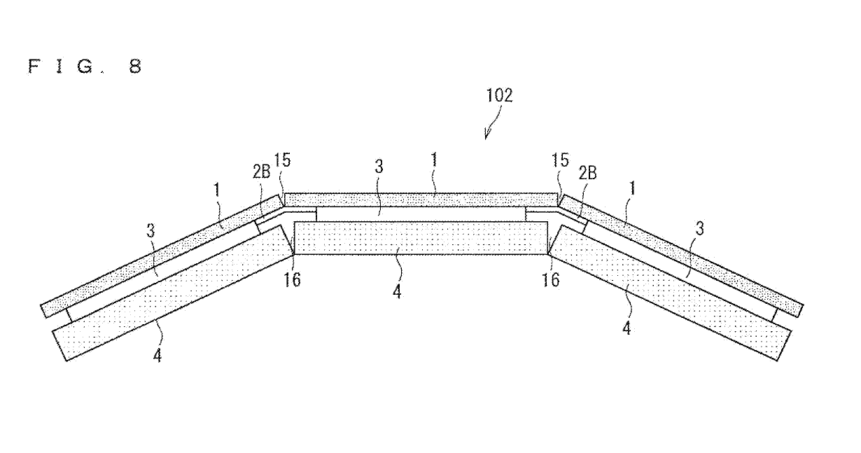

FIG. 7 is an exploded perspective view illustrating a schematic configuration of a display device 100B according to a modification 2 of the first preferred embodiment of the present invention. In the modification 2, the same reference numeral is assigned to a component having the same configuration as that in the display device 100 shown in FIG. 1, and the duplicate description will be omitted. Further, FIG. 8 is a side view illustrating the display device 100B used in a bent state so that an overall display surface thereof has a convex shape.

As shown in FIG. 7, in the display device 100B, a plurality of protection plates 1 are arranged so that back surfaces thereof face respective display surfaces 5 of respective display units 4, and so as to conform to the arrangement of the display units 4. In addition, a connecting sheet 2B which is composed of a flexible transparent material such as PET, polycarbonate, polyester, and silicon is stuck to back surfaces of the protection plates 1 so as to extend only between adjacent edges of adjacent protection plates 1.

The external form of the connecting sheet 2B is a rectangular shape and the length thereof is approximately the same as the length of the adjacent edges of the adjacent protection plates 1. The width of the connecting sheet 2B is set to be a size to extend between the adjacent edges of the adjacent protection plates 1, but not to be overlapped with areas above the display surfaces 5 of the display units 4. That is, the width is set so as to cover an area above adjacent frames of adjacent display units 4, but not to cover the areas above the display surfaces 5 of the display units 4.

Further, an adhesive (not shown) is applied to a front surface, namely a main surface that faces the back surfaces of the protection plates 1, of the connecting sheet 2B. Accordingly, the protection plates 1 are connected to each other by sticking the connecting sheet 2B to the protection plates 1 so as to extend between the adjacent edges of the adjacent protection plates 1.

The connecting sheet 2B and the display units 4 are bonded to each other in such a manner that translucent adhesive layers 3 which are provided so as to cover the respective display surfaces 5 of the respective display units 4, and the back surfaces of the protection plates 1 are stuck to the respective translucent adhesive layers 3. In this case, the back surface of each of the protection plates 1 and the display surface 5 of each of the display units 4 are directly bonded to each other by the respective translucent adhesive layers 3 and there is, therefore, no air space therebetween due to the presence of the translucent adhesive layer 3.

In this manner, sticking the connecting sheet 2B to the protection plates 1 so as to extend only between the adjacent edges of the adjacent protection plates 1 makes it possible to reduce the size of the connecting sheet 2B and therefore reduce the manufacturing cost.

Further, although the description has been made regarding the connecting sheet 2B that is composed of a transparent material, a constituent material of the connecting sheet 2B is not limited to a transparent material because the connecting sheet 2B is not overlapped with the display surfaces 5 of the display units 4.

### Second Preferred Embodiment

### Configuration of Device

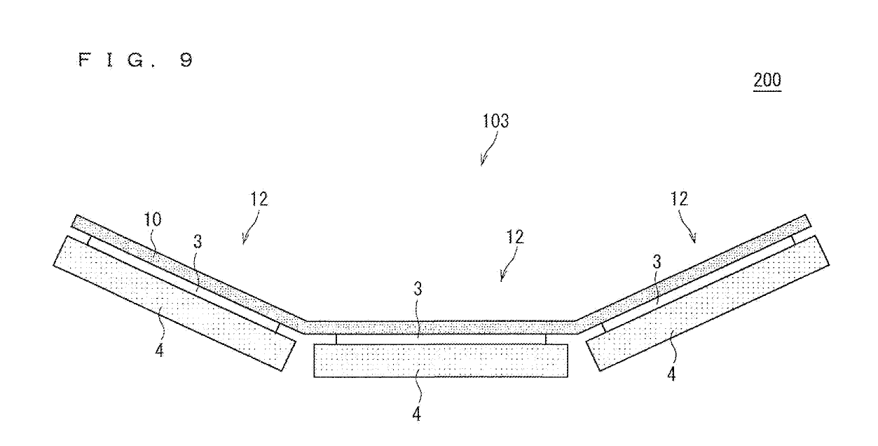

FIG. 9 is a side view illustrating a display device 200 according to a second preferred embodiment of the present invention. In the second preferred embodiment, the same reference numeral is assigned to a component having the same configuration as that in the display device 100 shown in FIG. 1, and the duplicate description will be omitted.

As shown in FIG. 9, in the display device 200, a protection plate 10 is bent at a plurality of bent portions which are located in a longitudinal direction so as to have a plurality of flat surface sections 12, and a plurality of display units 4 are stuck to respective back surfaces of the respective flat surface sections 12 to thereby connect the display units 4 to each other.

The protection plate 10 is composed of a transparent material such as acrylic, polycarbonate, and glass. The display units 4 are bonded to a back surface of the protection plate 10 by translucent adhesive layers 3 which are provided so as to cover respective display surfaces of the respective display units 4. In this case, the back surface of each of the flat surface sections 12 of the protection plate 10 and the display surface of each of the display units 4 are directly bonded to each other by the respective translucent adhesive layers 3 and there is, therefore, no air space therebetween due to the presence of the translucent adhesive layer 3.

Further, the protection plate 10 has a size to prevent the display units 4 from sticking out from the protection plate 10 when the display units 4 are stuck to the protection plate 10. Therefore, the display surface of each of the display units 4 is completely covered by the protection plate 10.

In the display device 200 shown in FIG. 9, the protection plate 10 is formed into a concavely bent shape with respect to the front side so that an overall display surface 103 has a concave shape.

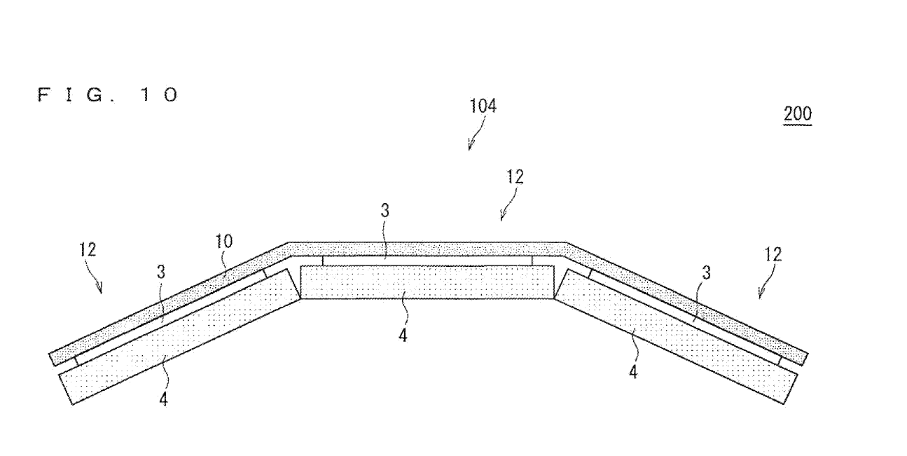

On the other hand, in the display device 200 shown in FIG. 10, the protection plate 10 is formed into a convexly bent shape with respect to the front side so that an overall display surface 104 has a convex shape.

As described above, in the display device 200 according to the second preferred embodiment, it is possible to obtain the display device 200 having the concave overall display surface 103 or the convex overall display surface 104 by sticking the display units 4 to the respective flat sections 12 of the protection plate 10 to thereby connect the display units 4 to each other.

Therefore, a complicated manufacturing process for causing curvature of a flat display panel that is composed of glass substrates is not required. As a result, a manufacturing process can be simplified. In addition, there is no possibility of damaging a flat display panel.

Further, since the display units 4 are connected by the protection plate 10, it is possible to connect the display units 4 to each other and position each of the display surfaces so as to face a different direction without increasing the number of components such as a hinge member.

Further, connecting the display units 4 by the protection plate 10 makes it possible to attain unity with each of the display surfaces and therefore provide a display device that has resistance to deformation caused by external forces.

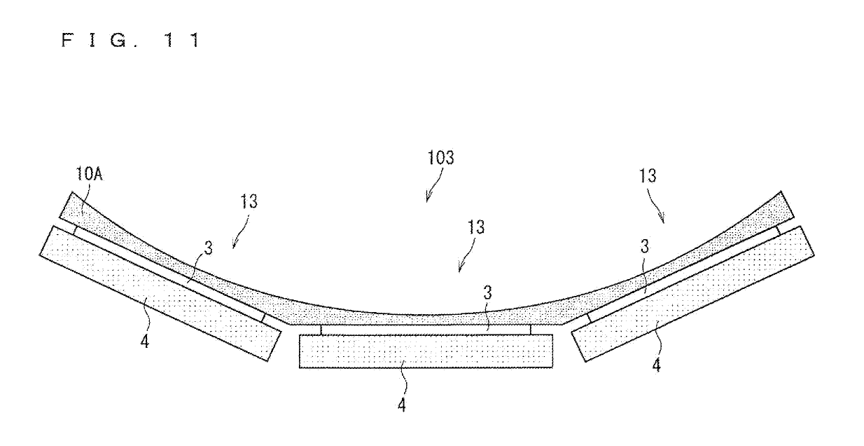

Further, although the protection plate 10 is bent at the bent portions which are located in a longitudinal direction so as to have the flat surface sections 12 in the above description, the protection plate 10 is not limited thereto. For example, as shown in FIG. 11, when the display device 200 is configured to have the concave overall display surface 103, a protection plate 10A in which one main surface (back surface) thereof to which the display units 4 are stuck is formed into a flat surface and the other main surface opposite to the back surface is formed to have concave surface sections 13 so that the overall display surface 103 as a whole is concavely curved may be used.

In this manner, conforming the shape of the front surface of the protection plate 10A to the shape of the concave overall display surface 103 of the display device 200 makes it possible to meet required specifications, shape or design.

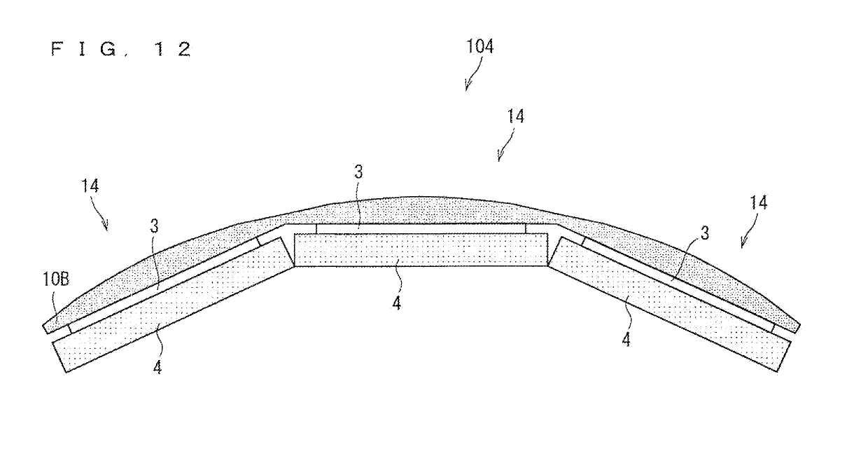

Further, as shown in FIG. 12, when the display device 200 is configured to have the convex overall display surface 104, a protection plate 10B in which one main surface (back surface) thereof to which the display units 4 are stuck is formed into a flat surface and the other main surface opposite to the back surface is formed to have convex surface sections 14 so that the overall display surface 104 as a whole is convexly curved may be used.

In this manner, conforming the shape of the front surface of the protection plate 10B to the shape of the convex overall display surface 104 of the display device 200 makes it possible to meet required specifications, shape or design.

Further, although, in the display devices of the first and second preferred embodiments described above, the descriptions have been made with regard to the case where the display units 4 are arranged in a row, the arrangement of the display units 4 is not limited thereto. The number of rows is not limited to any specific number and therefore can be two, three or the like. In addition, the number of the display units 4 per each row is not limited to any specific number as long as the number is more than one.

It is understood that modifications and omissions can be appropriately made to the preferred embodiments of the present invention without departing from the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a plurality of display units arranged with a predetermined space therebetween, each of said plurality of display units having a display surface and being capable of independently displaying an image;
a plurality of protection plates, each being disposed at a front of each of said plurality of display units with a back surface thereof facing each of said plurality of display units;
a connecting sheet having flexibility, said connecting sheet being stuck to said back surface of each of said plurality of protection plates to connect said plurality of protection plates to each other; and
translucent adhesive layers, each being disposed so as to cover said display surface of each of said plurality of display units,
wherein said plurality of protection plates connected by said connecting sheet are bonded to said plurality of display units by said translucent adhesive layers with said connecting sheet interposed therebetween or directly, so that said plurality of display units are connected to each other, and
wherein said display device can be configured so that said display surface of each of said plurality of display units faces a different direction by bending a connection part connected by said connecting sheet, said connection part corresponding to a position of said predetermined space between said plurality of display units.

2. The display device according to claim 1,
wherein said connecting sheet is stuck to said back surface of each of said plurality of protection plates so as to extend throughout said plurality of protection plates, and
wherein said plurality of protection plates are bonded to said translucent adhesive layers with said connecting sheet interposed therebetween.

3. The display device according to claim 1,
wherein said connecting sheet includes openings, each of said openings being positioned at a region overlapped with said display surface of each of said plurality of display units, and
wherein said plurality of protection plates are directly bonded to said translucent adhesive layers through said openings.

4. The display device according to claim 1,
wherein said connecting sheet is stuck to said back surface of each of adjacent protection plates of said plurality of protection plates so as to extend between adjacent edges of said adjacent protection plates, but not to be overlapped with an area above said display surface of each of said plurality of display units, and
wherein said plurality of protection plates are directly bonded to said translucent adhesive layers.

5. The display device according to claim 1, wherein, in each of said plurality of protection plates, said back surface is formed into a flat surface and a main surface opposite to said back surface is formed into a concave surface.

6. The display device according to claim 1, wherein, in each of said plurality of protection plates, said back surface is formed into a flat surface and a main surface opposite to said back surface is formed into a convex surface.

7. A display device comprising:
a plurality of display units, each having a display surface and being capable of independently displaying an image;
a protection plate disposed at a front of said plurality of display units with a back surface thereof facing said plurality of display units; and
translucent adhesive layers, each being disposed so as to cover said display surface of each of said plurality of display units,
wherein said protection plate is bent at a plurality of bent portions to have a plurality of sections each facing a different direction, and
wherein each of said plurality of display units is bonded to a back surface of each of said plurality of sections of said protection plate by each of said translucent adhesive layers, so that said plurality of display units are connected to each other and said display surface of each of said plurality of display units faces a different direction.

8. The display device according to claim 7, wherein, in each of said plurality of sections of said protection plate, said back surface is formed into a flat surface and a main surface opposite to said back surface is formed into a concave surface, so that an overall display surface as a whole has a concavely curved shape.

9. The display device according to claim 7, wherein, in each of said plurality of sections of said protection plate, said back surface is formed into a flat surface and a main surface opposite to said back surface is formed into a convex surface, so that an overall display surface as a whole has a convexly curved shape.
